(19) United States
(12) Patent Application Publication
(10) Pub. No.: US 2005/0111689 A1
(43) Pub. Date: May 26, 2005

(54) Loudspeaker with assembly and performance improvements

(75) Inventor: Robert J. True, Pleasant Prairie, WI (US)

Correspondence Address: Robert True, 8309 West Ridge Drive, Pleasant Prairie, WI, 53158, US

(73) Assignee: TRUE TECHNOLOGIES INC., Pleasant Prairie, WI (US)

(21) Appl. No.: 10/904,628

(22) Filed: Nov. 19, 2004

Related U.S. Application Data
(60) Provisional application No. 60/523,883, filed on Nov. 21, 2003.

(51) Int. Cl. H04R 1/00; H04R 9/06

(52) U.S. Cl. 381/423; 381/426

(57) ABSTRACT

A loudspeaker that incorporates features for improvements in performance, and quality while reducing component and manufacturing costs. One embodiment details a plastic frame with integrally molded spider. Another embodiment details a spider molded with individual legs that provides better control of the restorative force characteristic. The spider may also incorporate more than one plane of lateral stiffness to improve the loudspeakers tendency for voice coil rocking. An additional embodiment details a frame with generic mounting edge that mates with a secondary mounting flange that includes product specific requirements. The frame and mounting flange are separated by an outer section of the diaphragm suspension annulus that serves as vibration isolation. An additional outer section of the annulus can serve as a gasket to the mounting structure.

The present invention comprises a loudspeaker transducer that incorporates components molded from resin that improve the performance and quality while reducing component and manufacturing costs. The transducer is comprised of a frame molded from resin that provides structure to hold; a magnetic circuit comprised of steel pole pieces and a permanent magnet; a voice coil comprised of a loop of wire that generates an axial force when carrying electrical current and immersed in the magnetic field generated by the magnetic circuit; a diaphragm that creates a sound wave when driven by the voice coil with alternating current flowing in it; and one or more suspension components that supply a stiffness that serves as a restorative force that tends to move the diaphragm and voice coil back to their axial rest position. The amount or restorative force (total stiffness of the components) is controlled to achieve a desired low frequency performance of the system. Typically, there are two suspensions components. An upper suspension component between the frame and diaphragm is known as the annulus. The annulus also provides acoustic isolation between the front and rear sides of the diaphragm. A lower suspension component between the frame and the voice coil is known as the spider. It provides axial restorative force as well as a lateral centering force for the voice coil in the gap of the magnetic circuit.

In one embodiment of the invention, the spider is integrally molded from resin within the plastic frame. The molding of the spider can be a single shot process where the same material is used for the spider and the frame, a multi-shot process where different materials are used, or the spider can be manufactured separately from the frame and joined together with it using any process that reflows the plastic of one or both parts to effectively form a single component without the need for adhesive. Combining the spider and frame into a single part reduces component costs and manufacturing costs and improves quality by reducing the number of parts that need to be handled on the assembly line.

Spiders made from woven fibers treated with chemicals such as phenolic or acrylic have a tendency to vary in their stiffness from part to part due to variations in the fiber properties and the consistency of the chemical application. The treatment also tends to break down when the part is exercised and the stiffness of the part decreases with time. Spiders molded from synthetic materials or materials with a high natural consistency like rubber will exhibit reduced stiffness variation and their properties are less likely to change with exercise. The injection molding process also allows for a very accurate geometry and this further improves the consistency of the part. Since plastic and rubber materials are more consistent in their properties, the design process of the spider is easier and is more easily accomplished with use of computer modeling or analytical methods. The cost associated with trial-and-error spider sampling iterations are reduced and the design cycle is shortened.

The small excursion (linear) and large excursion (nonlinear) reactionary force can be controlled easily and independently by the type/composition of resin and the geometry of the spider. For example, the injection molding process allows for a continuously variable thickness of the region intended to flex and the stiffness of the part can be precisely chosen by selecting the appropriate thickness. This level of control offers a significant advantage over using woven cloth that is typically available only in standard thicknesses. To account for the discrete nature of the cloth thickness, the treatment of phenolic or other chemical must be varied to achieve the desired stiffness.

The molded spider can be made with individual legs that extend radially outward from a center ring that attaches to the voice coil to an outer ring that is part of the loudspeaker frame.

Since the individual legs in this spider design leave the voice coil unprotected from the environment, a soft thin gasket made of foam or other material can be placed above the spider such that it protects the voice coil from dust, debris, and moisture.

The spider legs can be created such that they are molded in pairs with adjacent legs being flipped vertically about a plane that is perpendicular to the axis of motion and that passes through the voice coil attachment ring. The alternating nature of the legs causes any asymmetries of the restorative force in the two directions of stretch to cancel. This reduces even order harmonic distortion and improves sound quality in a way that is not possible in traditional spiders.

The spider legs can be created such that they are made from one or more different shapes so that the summed restorative force off all legs results in reduced distortion, a desired force versus deflection characteristic or reduced resonances in the spider material. This is also not possible in traditional spiders.

The spider may be designed such that the ends of the legs are positioned at different vertical offsets on the inner or outer rings or both. This creates more than one plane of centering force and reduces the possibility of quality problems that can result from voice coil rocking. This allows for smaller clearances between the voice coil and motor parts and a stronger magnetic circuit with improved performance is possible. Traditional spiders formed from pressing cloth can only provide a single plane of centering force.

In another embodiment of the invention, the center ring of the spider that is intended to attach to the voice coil can be formed in a manner that when the voice coil is inserted it forms a pocket or well for adhesive. Adhering to some plastics can be very difficult. Achieving a strong bond at this location is critical since the joint is subjected to dynamic force loads that can cause a weak bond to deteriorate and fail. The glue well creates multiple surfaces for the adhesive to bond to. A further variation of this embodiment includes two glue wells—an upper well and a lower well. During assembly, a first glue bead is applied to the lower well while the speaker is positioned upside down. The speaker is then turned right side up and a second glue bead is applied to the upper glue well. This arrangement causes a middle horizontal wall of the dual glue well to be sandwiched between the two beads that adhere to both the voice coil bobbin and the spider inner ring. Hence, a much stronger mechanical bond is created between the parts. The horizontal wall can also be created with small holes or gaps in it so that the upper and lower glue beads blend together to essentially become a single bead at the openings. This creates and even stronger bond that captures the plastic ring within it. It is not possible to for a cloth spider with this type of glue well.

In a further embodiment of the invention, the inner ring may incorporate a feature that creates a landing or glue well to accommodate the attachment of the diaphragm at its inner opening. The glue well may be made such that the voice coil and cone fit together inside it and all three parts are bonded with a single glue bead.

The tool for molding the combined frame and spider can include a separate insert for molding the spider section. The insert section can be changed out to create variations in the spider to achieve differing performance requirements for different speaker models. The variations can include changes to the number of legs, the thickness of the legs, and the shape of one or more of the legs to control the spider force versus deflection characteristic. Making the tool with a separate section for the spider makes the tooling more cost effective since the frame tooling can be used for many different product applications.

In some cases, improvement to the spider's resistance to fatigue or reduction in the change in stiffness with temperature is desired. Changes to spider stiffness, damping, or mass characteristics may also be desired. The injection molding process offers advantages to traditional spiders in that there is more flexibility to achieve these objectives. For example, pieces of materials such as cloth or metal can be inserted into the tool and encapsulated by the resin during the molding process. Additionally, filler or additive materials in the resin may be used. It is also possible to mold the spider using multiple shots of different materials to build multilayered parts with the desired characteristics.

In a further embodiment of the invention, the lead wires (pigtails) that are soldered or crimped to the finer voice coil wire are insert molded into the inner or outer rings of the spider or both. When the voice coil is inserted into the inner ring, a solder or crimp connection is made near the voice coil and the joint is protected by the glue bead. This reduces labor on the assembly line and scrap associated with trimmed pigtails while improving product quality.

In another embodiment of this invention, small terminals can be insert molded into the spider inner ring to facilitate the connection of the fine voice coil wire to the pigtails.

In a further embodiment, the spider inner ring or outer ring or both have features molded into them to facilitate dressing of the pigtails by heat staking, sonic welding, riveting, adhesive, or other means.

In a further embodiment, the pigtails, whether insert molded or not, may be dressed between the spider legs in a way that they hang with an appropriate amount of slack to allow movement of the cone. The plastic frame may also include insert molded terminals that the pigtails are crimped or soldered to. These features make the tedious process of lead attachment much easier and more cost effective. In the case where both ends of the pig tail are crimped, the expensive and noxious soldering process is completely eliminated on the assembly line.

The dressing of the leads between the spider legs eliminates any need for the expensive process of running the pigtails partially up the face of the cone and then through holes pierced in the cone before running them to the terminals. It also eliminates any need for the undesirable need to provide additional space between the cone and spider to hang the leads as a direct connection from the voice coil to frame. This allows for a lower profile driver or a deeper cone that is less likely to have high frequency resonances that can cause frequency response irregularities and distortion problems. Dressing the leads between the spider legs also eliminates and need for the expensive process where the pigtails are woven or stitched into the spider cloth. Of course, the embodiment of the invention detailing the lead dress advantages applies to spiders with individual legs regardless of whether they are molded from resin or formed as a single piece with the frame.

The afore described spider molded from resin with any of the specific features of separate legs, alternating shapes, varied leg shapes, separation of vertical height at one or both ends, insert molding of cloth or metal or other materials, inclusion of additives or filler materials, multilayered legs of different materials, integrally molded lead wires, lead wires dressed between the legs and features for accomplishing this, features for otherwise dressing the leads such as insert molded terminals, or integral glue wells can be considered as a stand alone invention regardless of whether the spider is integrally molded within the speaker frame.

Since the tooling required to mold the suspension component into the frame can be expensive relative to the tools required to form traditional speaker components, another embodiment of the invention incorporates a frame that has a generic flange that attaches to a mating component (herein referred to as a mounting flange, though mounting features are not a requirement) that incorporates features for mounting, cosmetics, or other unique requirements that are specific to a particular product application. This allows a given standard size transducer frame (e.g., a 5¼″ or 6×9″) to be used over many product applications and the tooling can be amortized over much higher unit volumes and the cost becomes justifiable. The mounting flange can be attached to the frame edge with adhesive or with mechanical means such as fasteners or processes that re-flow the plastic such as heat staking or sonic welding. There may be special features molded into the frame edge and mounting flange to facilitate alignment and attachment.

In one method of attachment, the annulus attached to the diaphragm has an additional section outside the region intended to flex. This section is sandwiched between the generic frame edge and the mounting flange. Since both the frame and mounting flange are manufactured from hard materials, they can buzz when the transducer is excited and resonances in the components cause them to vibrate. Sandwiching the soft material between these parts creates a gasket that prevents the extraneous noise that results from buzzing. The sandwiched section of the annulus may include features such as punched holes or tabs to facilitate rotational and lateral alignment to the frame and mounting flange.

A variation of this embodiment includes an additional section of the annulus outside the sandwiched section. This section forms a gasket used to create a seal between the loudspeaker and another structure. The gasket can either be folded in front of the mounting flange for a front sealing gasket, or behind the frame edge to create a rear sealing gasket, or along the side. This outermost annulus section can be made so it is compressed more or less or molded to be thinner or thicker than the flexible roll or the sandwiched section in order to provide a certain sealing behavior. The frame edge and mounting flange can be designed so the assembly process that sandwiches the annulus also forces the gasket section to automatically fold around the edge of the frame. This feature eliminates the need for additional gaskets, adhesives to attach them, and the labor, fixtures, and machines required for assembly. Of course, embodiments of this invention that incorporate the sandwiched annulus section or integral gasket section can also be incorporated in speaker designs that use traditional frames made from metal or other materials.

### BRIEF DESCRIPTION OF THE DRAWINGS

These drawings show typical embodiments of the invention and are not intended to be limiting of the scope.

FIG. 1. Loudspeaker frame with integrally molded spider and generic outer edge.

FIG. 2. Loudspeaker frame with integrally molded spider showing lead dress between spider legs.

FIG. 3. Loudspeaker frame with integrally molded spider showing one style of leg, detail of integral glue well, and vertical offset of leg ends.

FIG. 4. Loudspeaker frame with integrally molded spider showing another style of leg, close up of integral glue well, and vertical offset of leg ends.

FIG. 5. Loudspeaker frame with generic outer edge, secondary mating component with mounting and product specific requirements, diaphragm with annulus including section to be sandwiched between frame and secondary mating component and outer gasket section.

FIG. 6. Assembly detail of frame and mating component sandwiching annulus section and creating rear gasket.

FIG. 7. Plan View of loudspeaker diaphragm with annulus showing sandwich section and die cut region for folded gasket.

### DETAILED DESCRIPTION OF THE DRAWINGS

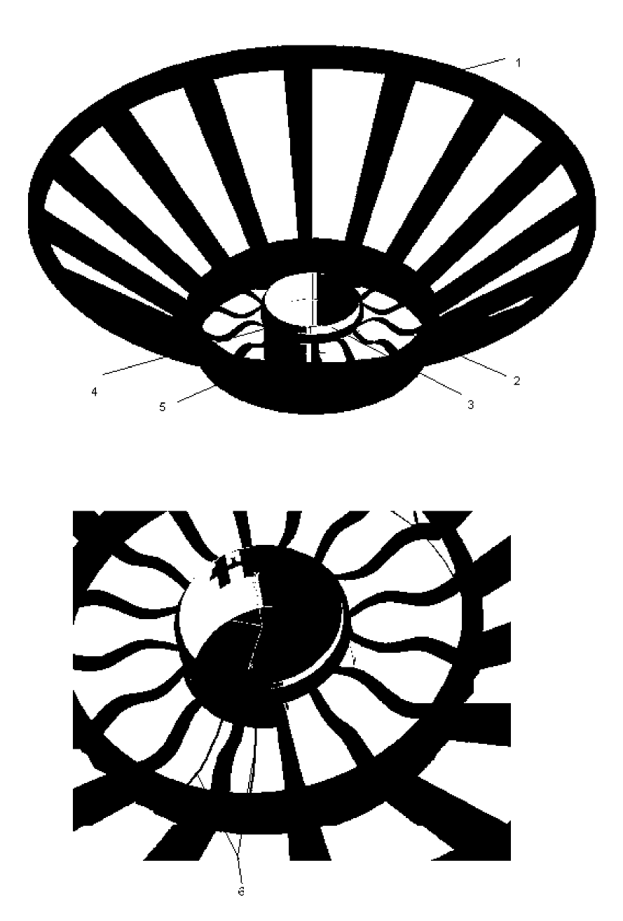

FIG. 1. Shows a plastic loudspeaker frame (1) with an integrally molded spider (2). The spider is formed from individual legs extending outward from the center ring that attaches to the voice coil bobbin (3) to an outer ring (5) that is part of the frame and also creates a mounting section for the motor. The frame (1) has a generic edge (27) that is designed to mate with a secondary component that includes mounting features and other product specific requirements.

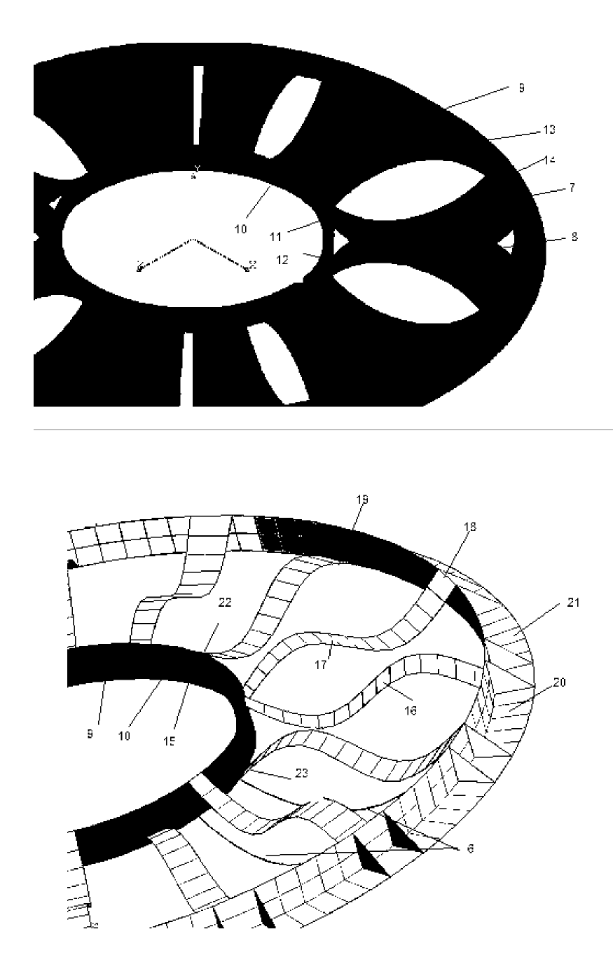

FIG. 2 shows a close up view of the integrally molded spider with the voice coil lead out wires or pigtails (6) hanging partially between the individual spider legs.

FIG. 3 shows a molded spider with individual legs extending radially outward from the center voice coil attachment ring. In this embodiment, the legs (7,8) are a single hump and legs alternate up (8) and down (7) in direction to create a perfectly symmetric restorative force characteristic. Leg (7) connects to the upper edge of the inner ring (11) and the upper edge of the outer ring (14) and leg (8) connects to the lower edge of the inner ring (12) and the lower edge of the outer ring (13). The vertical separation of legs creates multiple planes of lateral centering force for the voice coil and helps to reduce the tendency for the voice coil to rock. When the voice coil former (not shown in this figure) is inserted into the inner ring, a pocket or glue well is formed on the upper (9) and lower (10) sections of the inner ring. The horizontal section of the inner ring is trapped between the two glue beads and a superior mechanical connection is formed.

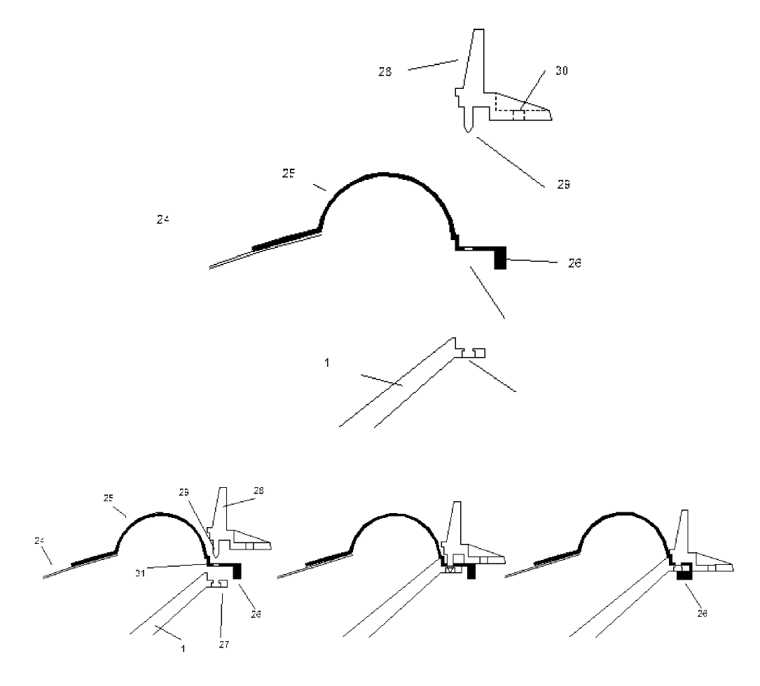

FIG. 4 shows a molded spider with individual legs extending radially outward from the center voice coil attachment ring. In this embodiment, the legs (16,17) are formed from a peak and a valley with leg (17) being the mirror image about a plane through the center ring of leg (16). There are an even number of legs with half being of the style of leg (17) and half being of the style of leg (16) with the adjacent legs alternating in style. The center ring forming glue wells (9) and (10) has small vertical sections (15) on each side of the horizontal center section that help improve the rigidity of the center ring. The voice coil lead out wires (6) are shown draped between the spider legs. The outer ring (20) has small vertical sections (21) for increasing stiffness of the outer wall.

FIG. 5 shows a cross section of the generic outer edge of the frame (1) with a hole and pocket (27) to mate with the secondary component (28) that retains the mounting holes (30) and other product specific requirements. The plastic post (29) is designed to either pass through a hole in the annulus section or puncture the annulus as it passes through the frame edge. The frame and secondary component are held together under pressure as the plastic post is melted with a tool to form a bond between the two pieces while sandwiching annulus section (31) to hold the diaphragm outer edge in place.

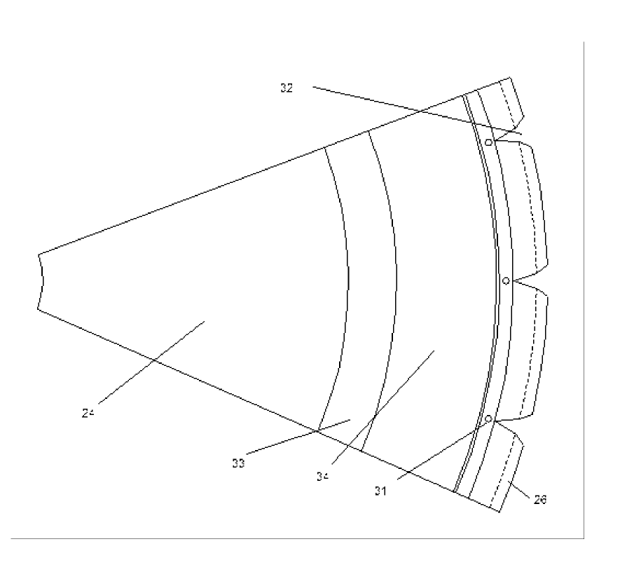

FIG. 6 shows the assembly process of the frame and mating component with the sandwiching of the annulus section and folding of the gasket section (26) around the back side of the frame.

FIG. 7 shows a plan view of the diaphragm (24) flexible annulus section (34) and attach region of annulus to diaphragm (33). The annulus sandwich section with pre-punched holes (31) is shown with the outer most section (26) that is formed such that the extra material that would bunch up during the folding process is removed (32) in the annulus forming process.

1. A loudspeaker having a drive mechanism that through some transduction means converts an audio signal to a mechanical motion of a diaphragm to create sound waves. The loudspeaker incorporates a frame molded from plastic resin that holds the individual components in proper relation. One or more suspension components are molded from plastic or rubber resin and used to provide restorative force in the direction of coil movement and/or a lateral force for keeping the voice coil centered in the motor gap. One or more of the molded suspension components are fixed in relation to the frame without the use of adhesive so that the frame can be considered to have an integral suspension component.

2. A loudspeaker of claim 1) where the one or more molded suspension components are formed using the same material as the frame and are molded simultaneously with the frame as a single component.

3. A loudspeaker of claim 1) where one or more molded suspension components are formed using a different material from the frame as part of a multi-shot molding process resulting in a single component.

4. A loudspeaker of claim 1) where one or more molded suspension components are formed using a different material from the frame. The one or more suspension components are over-molded on to the frame in a second operation to create a single component.

5. A loudspeaker of claim 1) where one or more molded suspension components are formed from plastic resin and fixed to the frame using any process where the plastic of the frame or the suspension component or both is reflowed to form a single component.

6. A loudspeaker having a drive mechanism that through some transduction means converts an audio signal to a mechanical motion of a diaphragm to create sound waves. The loudspeaker incorporates a frame that provides a structure to holds the components in proper relation. The frame outer edge is designed to mate with a secondary component that incorporates mounting or other features that change with product application and is assembled to the frame separately. The diaphragm is supported by a flexible annulus attached to the diaphragm outer edge that allows the diaphragm to move with the applied force. The annulus has an additional outer section that is sandwiched between the frame and the mating component as the means to attach the diaphragm to the frame.

7. A loudspeaker of claim 6) where the secondary mating component is assembled to the frame such that an annulus section outside the sandwiched section is folded around the frame outer edge to form a rear, side, or front gasket used for mechanical vibration isolation or as an air seal between the frame and another structure.

8. A loudspeaker of claim 7) where the secondary mating component forces the gasket formed from the annulus to fold around the outer edge of the frame during the assembly of the secondary mating component and frame.

9. A loudspeaker of claim 6) where the secondary mating component and frame are assembled while the two parts are pressed together to compress the annulus section between them.

10. A loudspeaker of claim 7) where the outer gasket section of the diaphragm annulus is die-cut or otherwise formed to facilitate folding it around the edge of the frame or secondary mating component.

11. A loudspeaker suspension component that provides a voice coil restorative force to the loudspeaker axial motion where two or more individual legs extend from a center ring to an outer ring with some of the legs altered in shape so the individual legs provide different restorative forces and the net sum of the restorative force from all legs provides a desirable characteristic not possible if all legs were formed with the same shape or if the component is formed from a piece that is solid or only perforated from the voice coil opening to the outer edge.

12. A loudspeaker suspension component that provides voice coil restorative force and lateral centering force where individual legs extend outward from a center ring with some of the legs being displaced vertically (in the axis of motion) at one or both ends of the leg to provide different planes of centering forces.

13. A loudspeaker suspension component molded from resin that provides voice coil restorative force where an integral center ring is molded that forms a glue well when the voice coil is inserted into the center ring.

14. A loudspeaker suspension component molded from resin that provides voice coil restorative force where an integral center ring is molded that forms an upper and lower glue well that results in a sandwiching of the center ring between the glue beads applied. The glue wells may be formed in such a way that small gaps or holes between the upper and lower wells allow the upper and lower adhesive beads to join and become a stronger capturing bond.

15. A loudspeaker suspension component molded from resin that provides voice coil restorative force and includes an integral center ring with features to facilitate alignment or adhesion of the diaphragm, dust cap, or secondary diaphragm.

16. A loudspeaker with a suspension component that provides voice coil restorative force where individual legs extend from a center ring and the leads from the voice coil extend outward and hang at least partially in the space between the spider legs.

17. A loudspeaker with a molded suspension component that provides voice coil restorative force and includes features for attaching the lead wires or pigtails from the voice coil at the inner or outer rings of the component or both. The features may include gaps or notches for placement or alignment of the lead wires, plastic sections design to be melted to heat stake or sonically weld the lead wires in place, glue wells for holding leads in place, or insert molded terminals to facilitate the connection of the voice coil and lead wires.

18. A loudspeaker with a suspension component that provides voice coil restorative force where individual legs are molded and extend from a center ring and the leg stiffness that dictates the amount of restorative force provided is controlled by varying the shape of one or more of the legs.

19. A loudspeaker with a suspension component that provides voice coil restorative force where individual legs are molded and extend from a center ring and the leg stiffness that dictates the amount of restorative force provided is controlled by selecting the type of material of the legs.

20. A loudspeaker with a suspension component that provides voice coil restorative force where individual legs are molded and additives or fillers in the resin or other materials are insert molded in the tool or multiple layers of materials are used to control stiffness, increase resistance to fatigue, or reduce stiffness changes due to temperature or other environmental changes.

21. A loudspeaker with a suspension component that provide voice coil restorative force where individual legs are covered by material to protect the voice coil and magnetic gap from dust, debris, and moisture.
